(19) United States
(12) Patent Application Publication
(10) Pub. No.: US 2019/0369533 A1
(43) Pub. Date: Dec. 5, 2019

(54) Image Forming Apparatus And Program

(71) Applicant: Konica Minolta, Inc., Tokyo (JP)

(72) Inventor: Hiroshi ASO, Tokyo (JP)

(73) Assignee: Konica Minolta, Inc., Tokyo (JP)

(21) Appl. No.: 16/392,952

(22) Filed: Apr. 24, 2019

(30) Foreign Application Priority Data
May 29, 2018 (JP) 2018-102446

(51) Int. Cl. G03G 15/20; G03G 15/00

(52) U.S. Cl. CPC G03G 15/2039; G03G 15/5062

(57) ABSTRACT

Disclosed is an image forming apparatus, which may be capable of forming an image on a continuous print medium and which may include: a fixing part that may come in contact with and heat a continuous print medium so as to fix an image formed on the continuous print medium; and a hardware processor that may perform temperature rise control of the fixing part. The fixing part may be capable of performing temperature rise control of the fixing part in a state where the contact of the fixing part with respect to the continuous print medium is released and the continuous print medium is stopped, and the hardware processor may prohibit the temperature rise control of the fixing part in a case where the hardware processor determines that a tension is not uniformly applied to the continuous print medium.

### CROSS REFERENCE TO RELATED APPLICATIONS

This application claims priority to Japanese Patent Application No. 2018-102446, filed on May 29, 2018, which is incorporated herein by reference in its entirety.

### BACKGROUND

### Technological Field

The present disclosure relates to an image forming apparatus and a program.

### Description of the Related Art

In a conventional electrophotographic image forming apparatus, laser light is emitted to a uniformly charged photoconductor and an electrostatic latent image is formed, and toner is supplied to the photoconductor carrying the electrostatic latent image and an image is formed. The image is transferred to a sheet by a transfer nip, and then, the sheet is heated and pressed, whereby the toner image is fixed onto the sheet, leading to image formation on the sheet.

Meanwhile, in image formation on a continuous print medium, the image forming apparatus sometimes is left in a state in which the continuous print medium is pinched by a fixing nip. In the state of being left in this manner, heat transmitted through the fixing nip to the continuous print medium might cause deformation of the continuous print medium. To avoid this, the nip is released in a case where image formation is stopped.

However, simply releasing the fixing nip would not eliminate the possibility of deformation of the continuous print medium because heat is transmitted to the continuous print medium via the air. Thermal deformation in a part of the continuous print medium might bring this part into contact with a fixing surface side being a part of the fixing nip. Occurrence of contact in a part of the continuous print medium with the fixing surface side being a part of the fixing nip might cause a scratch on the fixing surface side, leading to image quality degradation. In view of this, there is a proposed technique of moving the continuous print medium in a state where the fixing nip is released so as to suppress deformation of the continuous print medium caused by the heat from a fixing surface-side member, thereby suppressing image quality degradation (for example, refer to JP 2016-180925 A).

However, in the conventional technique as described in JP 2016-180925 A, the continuous print medium is moved by warm-up operation before the start of image formation. This would produce sheet spoilage not to be used for printing, increasing the printing cost. This leads to a situation having difficulty in suppressing an increase in printing cost and image quality degradation.

### SUMMARY

The present disclosure has been made in view of such situation, and aims to suppress an increase in printing cost and image quality degradation.

To achieve the above-mentioned object, according to an aspect of the present disclosure, there is provided an image forming apparatus that may be capable of forming an image on a continuous print medium. The image forming apparatus, reflecting one aspect of the present disclosure, may comprise: a fixing part that may come in contact with and heat a continuous print medium so as to fix an image formed on the continuous print medium; and a hardware processor that may perform temperature rise control of the fixing part. The fixing part may be capable of performing temperature rise control of the fixing part in a state where the contact of the fixing part with respect to the continuous print medium is released and the continuous print medium is stopped, and the hardware processor may prohibit the temperature rise control of the fixing part in a case where the hardware processor determines that a tension is not uniformly applied to the continuous print medium.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the present invention:

FIG. 1 is a view illustrating an overall configuration example of an image forming apparatus according to a first embodiment of the present disclosure;

FIG. 2 is a view illustrating a detailed configuration example of a fixing part according to the first embodiment of the present disclosure;

FIG. 3 is a view illustrating a configuration example of a tension application mechanism according to the first embodiment of the present disclosure;

FIG. 4 is a view illustrating a configuration example of a load detector according to the first embodiment of the present disclosure;

FIG. 5 is a view illustrating a configuration example of a slack detector according to the first embodiment of the present disclosure;

FIG. 6 is a flowchart illustrating an example of permission determination processing of temperature rise control of the image forming apparatus according to the first embodiment of the present disclosure;

FIG. 7 is a flowchart illustrating an example of temperature rise control and maintenance control of the image forming apparatus according to the first embodiment of the present disclosure;

FIG. 8 is a flowchart illustrating an example of permission determination processing of temperature rise control of the image forming apparatus according to a second embodiment of the present disclosure;

FIG. 9 is a flowchart illustrating an example of temperature rise control and maintenance control of the image forming apparatus according to the second embodiment of the present disclosure;

FIG. 10 is a flowchart illustrating an example of permission determination processing of temperature rise control of the image forming apparatus according to a third embodiment of the present disclosure; and

FIG. 11 is a flowchart illustrating an example of temperature rise control and maintenance control of the image forming apparatus according to a fourth embodiment of the present disclosure.

### DETAILED DESCRIPTION OF EMBODIMENTS

Hereinafter, one or more embodiments of the present disclosure will be described with reference to the drawings. However, the scope of the disclosure is not limited to the disclosed embodiments.

### First Embodiment

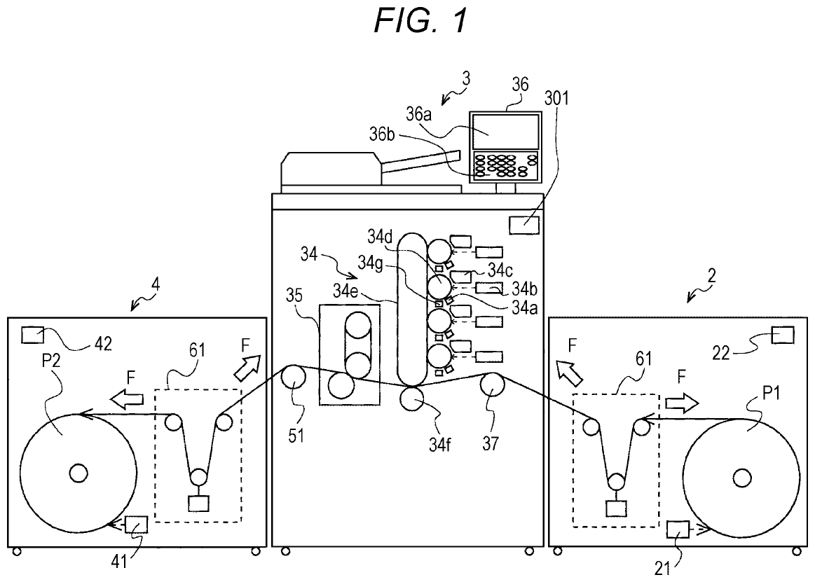

FIG. 1 is a view illustrating an overall configuration example of an image forming apparatus 3 according to a first embodiment of the present disclosure. The image forming apparatus 3 has a sheet feeder 2 provided at its upstream side and has a winding apparatus 4 provided at its downstream side. The image forming apparatus 3 includes an image forming part 34, a fixing part 35, and a control unit 301. The sheet feeder 2 contains a roll type continuous print medium P1. The winding apparatus 4 stores a continuous print medium P2 in a roll form. The continuous print medium P1 and the continuous print medium P2 will be collectively referred to as a continuous print medium P. The image forming apparatus 3 may include at least one of the sheet feeder 2 and the winding apparatus 4. The sheet feeder 2 includes a sheet feed driver 21, a control part 22, and a tension application mechanism 61. The sheet feed driver 21 includes a servo motor, for example, and drives on the basis of a control command from the control part 22 and thereby controls the rotation speed of the continuous print medium P1. The tension application mechanism 61 is provided on the downstream side of the roll type continuous print medium P1, and applies a tension F to the continuous print medium P1. The sheet feeder 2 feeds the continuous print medium P1 to the image forming apparatus 3 via the tension application mechanism 61, thereby supplying the continuous print medium P1 to which the tension F has been applied, to the image forming apparatus 3. Details of the tension application mechanism 61 will be described below. The winding apparatus 4 winds up the continuous print medium P carrying an image formed by the image forming apparatus 3 and stores the medium P as the roll type continuous print medium P2. The winding apparatus 4 includes a winding driver 41, a control unit 42, and the tension application mechanism 61. The winding driver 41 is constituted by, for example, a servo motor, and controls the rotation speed of the continuous print medium P2 by driving on the basis of a control command of the control unit 42. The tension application mechanism 61 is provided on the upstream side of the roll type continuous print medium P2 and applies the tension F to the continuous print medium P2. The winding apparatus 4 winds up the sheet as a roll type continuous print medium P2 via the tension application mechanism 61 and thereby stores the continuous print medium P2 to which the tension F has been applied to the continuous print medium P, output from the image forming apparatus 3. Within the image forming apparatus 3, the continuous print medium P is conveyed by a conveyance roller 37 and discharged after being conveyed through the image forming part 34, the fixing part 35, and a load detector 51.

The image forming apparatus 3 includes a setting part 36 at the top. The setting part 36 includes a display part 36a and an operation part 36b. The setting part 36 receives user's operation via the operation part 36b and displays information by the display part 36a. The image forming apparatus 3 includes, at its top, an automatic document feeder and a document image scanner for automatically reading a document. The document image scanner is capable of reading an image via platen glass. The document image scanner reads an image of a document and uses the image for image formation by the image forming part 34. The image forming part 34 includes a photoconductor 34d individually prepared for each of colors such as cyan, magenta, yellow, black, or the like. There are provided a charging device 34a, an exposing device 34b, and a developing device 34c individually around the photoconductor 34d.

Image exposure is performed by the exposing device 34b onto the surface of the photoconductor 34d charged by the charging device 34a on the basis of document image data in a print job, resulting in formation of an electrostatic latent image. The electrostatic latent image is developed by the developing device 34c to form an image. The image is transferred to the intermediate transfer belt 34e. The image transferred to the intermediate transfer belt 34e is crimped and transferred to the continuous print medium P by a secondary transfer roller 34f. The image that is crimped and transferred by the secondary transfer roller 34f is heated and pressed by the fixing part 35 and fixed to the continuous print medium P. As a result, an image is formed on the continuous print medium P by the image forming apparatus 3. That is, the image forming part 34 is capable of forming an image on the continuous print medium P by the electrophotographic method. Note that a drum cleaning device 34g is provided around the photoconductor 34d. The drum cleaning device 34g removes residual toner on the intermediate transfer belt 34e. The control unit 301 includes a CPU, a ROM, a RAM, an I/O interface, or the like (not illustrated) and is used as a computer that controls the image forming apparatus 3. The CPU reads a program corresponding to processing content from the ROM, develops the program in the RAM, and controls operation of the image forming apparatus 3 in cooperation with the developed program. The program is provided to implement various control functions. The control unit 301 is also used as a processor mainly configured with a CPU.

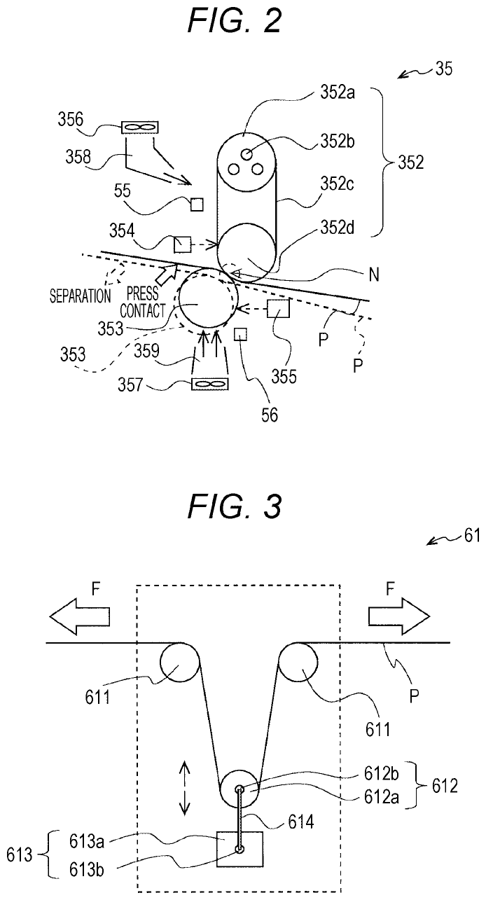

FIG. 2 is a view illustrating a detailed configuration example of the fixing part 35 according to the first embodiment of the present disclosure. The fixing part 35 includes a first rotatable member 352 and a second rotatable member 353. The first rotatable member 352 includes a heating roller 352a, a heating source 352b, a fixing belt 352c, and an upper pressure roller 352d. The second rotatable member 353 functions as a lower pressure roller. The heating source 352b is provided inside the heating roller 352a and can raise the temperature, and heats the heating roller 352a. The upper pressure roller 352d is provided below the heating roller 352a. The fixing belt 352c is formed in an endless shape and is wound around the heating roller 352a and the upper pressure roller 352d. The second rotatable member 353 functioning as a lower pressure roller is in press contact with the upper pressure roller 352d, whereby a fixing nip N is formed via the fixing belt 352c. The fixing nip N is released when the second rotatable member 353 is separated from the upper pressure roller 352d, namely, from the first rotatable member 352. With the tension F applied to the continuous print medium P, the continuous print medium P would be wound around the second rotatable member 353 even when the fixing nip N is released.

The first rotatable member 352 is driven by the upper driving unit 354. The upper driving unit 354 is controlled by the control unit 301 so as to cause the first rotatable member 352 to run at a constant speed. For example, the upper driving unit 354 drives the upper pressure roller 352d, whereby the heat supplied from the heating roller 352a via the fixing belt 352c is transmitted to the fixing nip N formed in the upper pressure roller 352d while the fixing belt 352c is running at a constant speed. Therefore, the temperature of the fixing belt 352c can be regarded as the temperature of the first rotatable member 352. The second rotatable member 353 is driven by the lower driving unit 355. The lower driving unit 355 is controlled by the control unit 301 so as to separate the second rotatable member 353 from the first rotatable member 352 or bring the second rotatable member 353 to be in press contact with the first rotatable member 352. In other words, the positional relationship between the upper pressure roller 352d and the second rotatable member 353 functioning as the lower pressure roller is one of the separated state and the press contact state.

There is provided an upper temperature detector 55 at a position facing the fixing belt 352c. The upper temperature detector 55 detects the temperature of the fixing belt 352c. There may a lower temperature detector 56 provided around the second rotatable member 353. The lower temperature detector 56 detects the temperature around the second rotatable member 353. While the heat is transmitted from the first rotatable member 352 to the second rotatable member 353 via the fixing nip N, the second rotatable member 353 may include a member similar to the heating source 352b.

There is provided an upper blower fan 356 around the first rotatable member 352. There is provided an upper duct 358 at a blowout port of the upper blower fan 356. The blowout port of the upper duct 358 faces the surface of the fixing belt 352c. Accordingly, the air supplied from the upper blower fan 356 can be blown to the surface of the fixing belt 352c, making it possible to cool the entire first rotatable member 352 in addition to the fixing belt 352c. It is also possible to transmit the heat of the first rotatable member 352 to the outside of the image forming apparatus 3 via the continuous print medium P when the continuous print medium P is conveyed. There is provided a lower blower fan 357 around the second rotatable member 353. There is provided a lower duct 359 at a blowout port of the lower blower fan 357. The blowout port of the lower duct 359 is directed to a curvature surface of the second rotatable member 353. Accordingly, the air supplied from the lower blower fan 357 can be blown to the curvature surface of the second rotatable member 353, making it possible to cool entire portions of the second rotatable member 353.

FIG. 3 is a view illustrating a configuration example of the tension application mechanism 61 according to the first embodiment of the present disclosure. The tension application mechanism 61 includes a driven roller 611, a dancer roller 612, and a weight 613. The dancer roller 612 includes a roller main body 612a and a roller support shaft 612b. The roller main body 612a is vertically movable together with the roller support shaft 612b. The weight 613 includes a weight main body 613a and a weight support shaft 613b. The tension F is determined in accordance with the weight of the weight 613. A load of the weight 613 is applied to the dancer roller 612 via the support member 614 connecting the roller support shaft 612b and the weight support shaft 613b. The continuous print medium P is supported by the dancer roller 612 and the two driven rollers 611. This causes the dancer roller 612 together with the two driven rollers 611 to be driven to rotate in the rotational direction and vertically movably supported, with the moving range restricted in the vertical direction. The rotational speeds of the servo motors of the sheet feed driver 21 and the winding driver 41 are controlled to locate the dancer roller 612 at a fixed position. That is, the position of the dancer roller 612 depends on an input/output speed difference between the sheet feed driver 21 and the winding driver 41. Note that loss of power supply to the sheet feeder 2 and the winding apparatus 4, that is, interruption of power supply would stop power supply to the sheet feed driver 21 and the winding driver 41. Accordingly, the dancer roller 612 falls down due to the load applied by the weight 613 up to the lower limit of the moving range and its own weight. This results in a state where the tension F is not applied to the continuous print medium P.

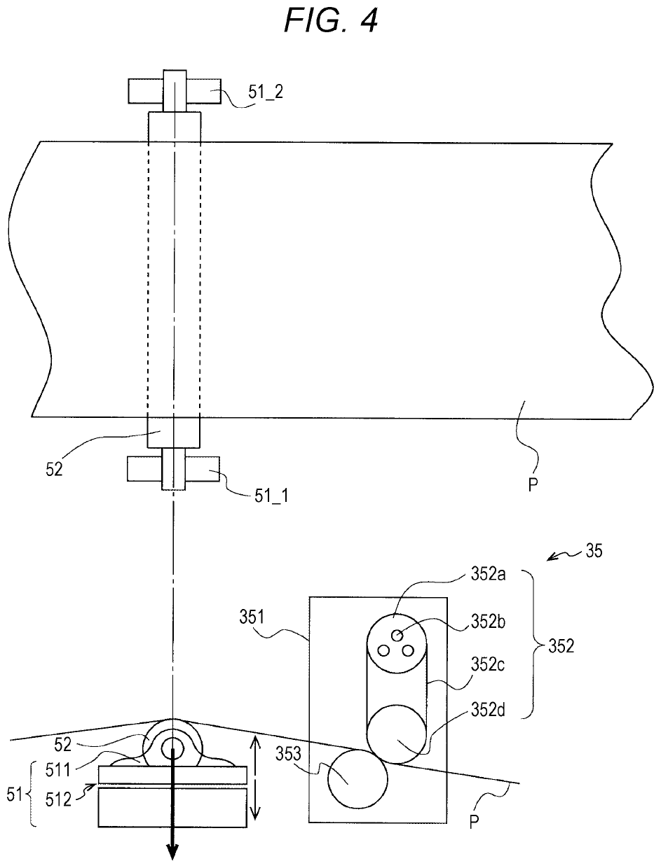

FIG. 4 is a view illustrating a configuration example of the load detector 51 according to the first embodiment of the present disclosure. The load detector 51 includes an attachment portion 511 and a sensor portion 512. The sensor portion 512 detects a load applied to the attachment portion 511. The tension detection roller 52 is slidably attached to the attachment portion 511, and the load received from the continuous print medium P is transmitted to the sensor portion 512 via the attachment portion 511. The load detector 51 includes a first load detector 51_1 and a second load detector 51_2. The first load detector 51_1 is provided at one end side of both ends of the short side of the continuous print medium P, and detects a load on one end side of the continuous print medium P. The second load detector 51_2 is provided on the other end side of both ends on the short side of the continuous print medium P, and detects a load on the other end side of the continuous print medium P. In a case where a difference between the detection result of the first load detector 51_1 and the detection result of the second load detector 51_2 falls within a range of a preset load tolerance value, the control unit 301 determines that the tension F is uniformly applied to the continuous print medium P. That is, in a case where the tension F is uniformly applied to the continuous print medium P, the detection result of the first load detector 51_1 and the detection result of the second load detector 51_2 are substantially the same value. In a case where floating occurs on one side of both ends of the short side of the continuous print medium P due to some cause, the detection result of the load at a position of occurrence of the floating would indicate a small value. Accordingly, execution of comparison operation of the detection results of the first load detector 51_1 and the second load detector 51_2 would make it possible to detect the floating of the continuous print medium P.

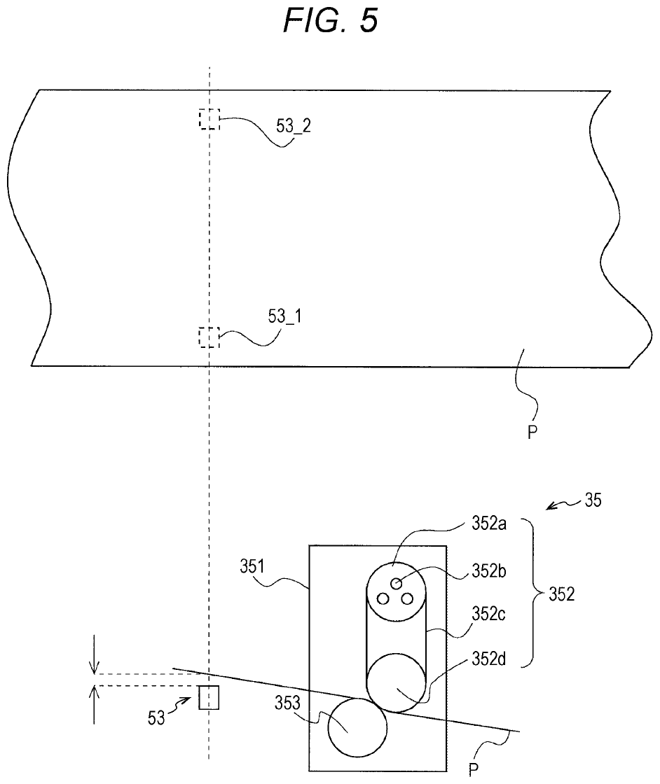

FIG. 5 is a view illustrating a configuration example of a slack detector 53 according to the first embodiment of the present disclosure. The slack detector 53 includes a first slack detector 53_1 and a second slack detector 53_2. The first slack detector 53_1 includes an ultrasonic sensor, for example. The first slack detector 53_1 is provided on one end side of both ends of the short side of the continuous print medium P, and detects slack at one end side of the continuous print medium P. The second slack detector 53_2 includes an ultrasonic sensor, for example. The second slack detector 53_2 is provided on the other end side of both ends of the short side of the continuous print medium P, and detects slack at the other end side of the continuous print medium P. In a case where it is detected that slack has not occurred on one end side or the other end side of the continuous print medium P on the basis of the detection results of the first slack detector 53_1 and the second slack detector 53_2, the control unit 301 determines that the tension F is uniformly applied to the continuous print medium P. Note that the slack detector 53 may be of a digital type or of an analog type. In the case of an analog type, it would be allowable when the detection result of the slack detector 53 falls within a range of a preset slack tolerance value.

As described above, the electrophotographic image forming apparatus 3 uses the fixing part 35 and heats and presses the continuous print medium P, thereby fixing a toner image on the continuous print medium P. Accordingly, the control unit 301 performs temperature rise control of the fixing part 35 until the temperature of the fixing part 35 reaches a temperature at which the toner image can be fixed on the continuous print medium P. The temperature rise control of the fixing part 35 is performed before execution of image formation on the continuous print medium P, that is, at the time of warm-up before the start of printing. There is a need, however, to temporarily prohibit the temperature rise control or to change a parameter of temperature rise control depending on the state of the continuous print medium P. Specifically, executing the temperature rise control under the condition that the tension F is not uniformly applied to the continuous print medium P might cause thermal deformation in the continuous print medium P, leading to a possibility that a thermally deformed portion in the continuous print medium P would come in contact with the surface of the fixing belt 352c. The contact of a part of the continuous print medium P with the surface of the fixing belt 352c would cause a scratch on the surface of the fixing belt 352c. Such a scratch causes image quality degradation. To avoid this, when such a state is expected, the temperature rise control is temporarily prohibited at first.

Specifically, in a case where the control unit 301 determines that the tension F is not uniformly applied to the continuous print medium P, the control unit 301 prohibits the temperature rise control of the fixing part 35. Note that when the tension F is uniformly applied to the continuous print medium P, the above-described state is not expected, and thus, the temperature rise control is permitted. Specifically, the control unit 301 determines that the fixing nip N is released and the tension F is uniformly applied to the continuous print medium P, the control unit 301 permits the temperature rise control. The continuous print medium P, however, is wound around the second rotatable member 353 with application of the tension F. Whether the tension F is uniformly applied to the continuous print medium P may be determined as follows. In a case where a conveyance distance of the continuous print medium P, that is, a distance by which the continuous print medium P is conveyed while being pinched by the fixing part 35 at the fixing nip N has reached a preset target distance, the control unit 301 determines that the tension F is uniformly applied to the continuous print medium P. The target distance can be set by driving the sheet feeder 2 and the winding apparatus 4, conveying the continuous print medium P by the image forming apparatus 3, and then, preliminarily measuring a distance enabling stabled positions of both ends of the continuous print medium P on the short side.

Moreover, in execution of the temperature rise control, parameters for temperature rise control are set in accordance with the type of continuous print medium P. Specifically, the control unit 301 sets the target temperature of the temperature rise control in accordance with the type of the continuous print medium P. The target temperature of the temperature rise control is a temperature that enables the toner image to be fixed on the continuous print medium P. That is, the temperature of the fixing part 35 may preferably be raised to the target temperature of the temperature rise control. The temperature of the fixing part 35 is obtained with reference to the temperature of the fixing belt 352c detected by the upper temperature detector 55. The temperature of the fixing belt 352c can be regarded as equivalent to the temperature of the first rotatable member 352. The temperature of the first rotatable member 352 and the temperature of the fixing part 35 have a certain correlation. Therefore, detecting the temperature of the fixing belt 352c can be regarded as detecting the temperature of the fixing part 35. In a case where the temperature of the fixing part 35 is to be detected with higher accuracy, the temperature of the second rotatable member 353 may also be detected and used for control together with the temperature of the first rotatable member 352.

In addition, in order to shorten the warm-up time after the temperature rise control is executed, maintenance control of maintaining the temperature of the fixing part 35 is performed under a certain condition. Specifically, the control unit 301 stops the maintenance control in a case where a time for continuing the maintenance control of maintaining the temperature of the fixing part 35 at a target temperature of the temperature rise control has exceeded a threshold time. The threshold time is set in accordance with the thermal deformation amount of the continuous print medium P. The control unit 301 reduces the threshold time for the continuous print medium P having a large thermal deformation amount. The control unit 301 can extend the threshold time for the continuous print medium P having a small thermal deformation amount. The control unit 301 may preliminarily store the type of the continuous print medium P and the threshold time in a control table and may determine the threshold time with reference to the control table. In the case where the continuous print medium P has a large thermal deformation amount, it is preferable to set the time to fall within a range smaller than the separation distance of the fixing nip N as the threshold time even when the continuous print medium P is thermally deformed.

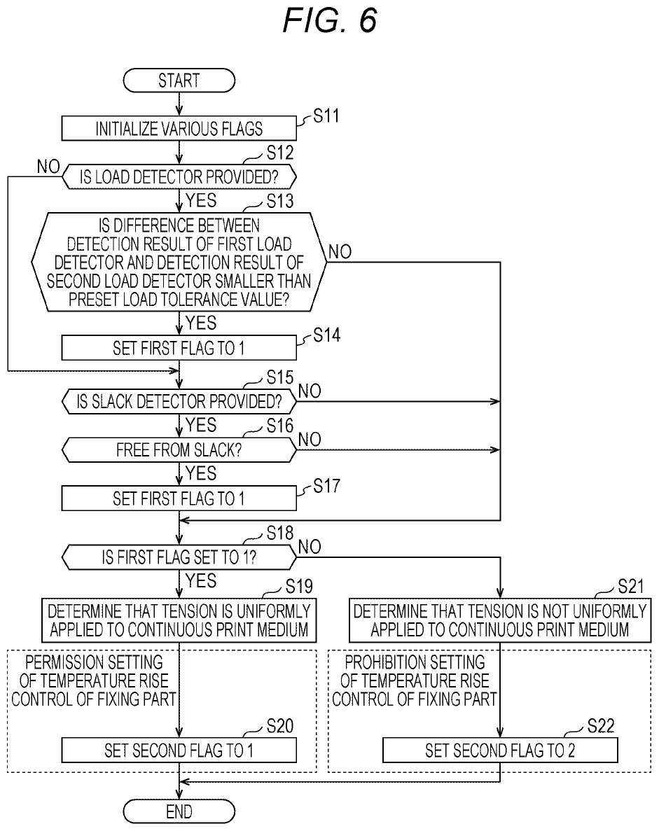

FIG. 6 is a flowchart illustrating an example of permission determination processing of temperature rise control of the image forming apparatus 3 according to the first embodiment of the present disclosure. In step S11, the control unit 301 initializes various flags. In step S12, the control unit 301 determines whether the load detector 51 is provided. In a case where the control unit 301 determines that the load detector 51 is provided (step S12; Y), the control unit 301 proceeds to processing of step S13. In a case where the control unit 301 determines that the load detector 51 is not provided (step S12; N), the control unit 301 proceeds to processing of step S15. In step S13, the control unit 301 determines whether the difference between the detection result of the first load detector 51_1 and the detection result of the second load detector 51_2 is smaller than a preset load tolerance value. In a case where the control unit 301 determines that the difference between the detection result of the first load detector 51_1 and the detection result of the second load detector 51_2 is smaller than the preset load tolerance value (step S13; Y), the processing proceeds to step S14. In a case where the control unit 301 determines that the difference between the detection result of the first load detector 51_1 and the detection result of the second load detector 51_2 is the preset load tolerance value or more (step S13; N), the processing proceeds to step S18.

In step S14, the control unit 301 sets a first flag to 1. In step S15, the control unit 301 determines whether the slack detector 53 is provided. In a case where the control unit 301 determines that the slack detector 53 is provided (step S15; Y), processing proceeds to step S16. In a case where the control unit 301 determines that the slack detector 53 is not provided (step S15; N), the processing proceeds to step S18. In step S16, the control unit 301 determines whether it is in a state free from slack. In a case where the control unit 301 determines that it is free from slack (step S16; Y), processing proceeds to step S17. In a case where the control unit 301 determines that slack has occurred (step S16; N), the processing proceeds to step S18. In step S17, the control unit 301 sets the first flag to 1.

In step S18, the control unit 301 determines whether the first flag is set to 1. In a case where the control unit 301 determines that the first flag is set to 1 (step S18; Y), processing proceeds to step S19. In a case where the control unit 301 determines that the first flag is not set to 1 (step S18; N), the processing proceeds to step S21. In step S19, the control unit 301 determines that the tension F is uniformly applied to the continuous print medium P. In step S20, the control unit 301 sets a second flag to 1 and finishes the processing of steps S11 to S20. Note that the processing of step S20 is a permission setting of temperature rise control of the fixing part 35. In step S21, the control unit 301 determines that the tension F is not uniformly applied to the continuous print medium P. In step S22, the control unit 301 sets the second flag to 2, and finishes the processing in steps S11 to S18, S21, and S22. Note that the processing of step S22 is prohibition setting of the temperature rise control of the fixing part 35.

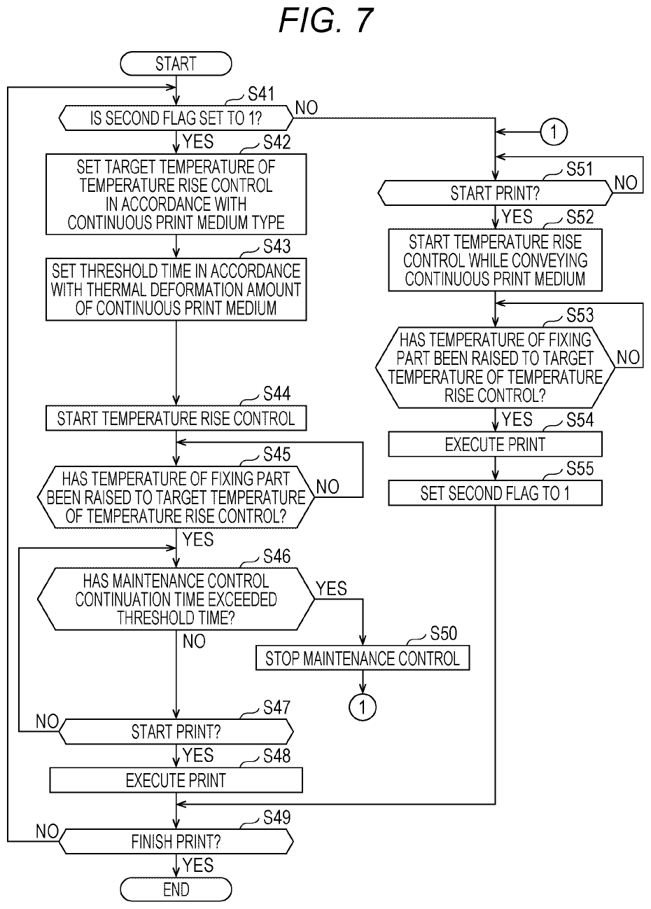

FIG. 7 is a flowchart illustrating an example of temperature rise control and maintenance control of the image forming apparatus 3 according to the first embodiment of the present disclosure. In step S41, the control unit 301 determines whether the second flag is set to 1. In a case where the control unit 301 determines that the second flag is set to 1 (step S41; Y), processing proceeds to step S42. In a case where the control unit 301 determines that the second flag is not set to 1 (step S41; N), the processing proceeds to step S51. In step S42, the control unit 301 sets a target temperature of the temperature rise control in accordance with the type of the continuous print medium P. In step S43, the control unit 301 sets the threshold time in accordance with the thermal deformation amount of the continuous print medium P. In step S44, the control unit 301 starts the temperature rise control. In step S45, the control unit 301 determines whether the temperature of the fixing part 35 has been raised to the target temperature of the temperature rise control. In a case where the control unit 301 determines that the temperature of the fixing part 35 has been raised to the target temperature of the temperature rise control (step S45; Y), processing proceeds to step S46. In a case where the control unit 301 determines that the temperature of the fixing part 35 has not been raised to the target temperature of the temperature rise control (step S45; N), the control unit 301 continues the processing of step S45.

In step S46, the control unit 301 determines whether the time for continuing the maintenance control has exceeded a threshold time. In a case where the control unit 301 determines that the time period for continuing the maintenance control has exceeded the threshold time (step S46; Y), the processing proceeds to step S50. In a case where the control unit 301 determines that the time for continuing the maintenance control has not exceeded the threshold time (step S46; N), the processing proceeds to step S47. In step S47, the control unit 301 determines whether to start printing. In a case where the control unit 301 determines that printing is to be started (step S47; Y), processing proceeds to step S48. In a case where the control unit 301 determines that printing is not to be started (step S47; N), the processing returns to step S46. In step S48, the image forming apparatus 3 performs printing. In step S49, the control unit 301 determines whether to finish printing. In a case where the control unit 301 determines to finish printing (step S49; Y), the processing of steps S41 to S49 or the processing of steps S50 to S57 and S49 are finished. In a case where the control unit 301 determines that printing should not be ended (step S49; N), the processing returns to step S41.

In step S50, the control unit 301 stops the maintenance control, and proceeds to the processing of step S51. In step S51, the control unit 301 determines whether to start printing. In a case where the control unit 301 determines that printing is to be started (step S51; Y), processing proceeds to step S52. In a case where the control unit 301 determines that printing is not to be started (step S51; N), the processing of step S51 is continued. In step S52, the image forming apparatus 3 starts temperature rise control while conveying the continuous print medium P.

In step S53, the control unit 301 determines whether the temperature of the fixing part 35 has been raised to the target temperature of the temperature rise control. In a case where the control unit 301 determines that the temperature of the fixing part 35 has been raised to the target temperature of the temperature rise control (step S53; Y), processing proceeds to step S54. In a case where the control unit 301 determines that the temperature of the fixing part 35 has not been raised to the target temperature of the temperature rise control (step S53; N), the control unit 301 continues the processing of step S53. In step S54, the image forming apparatus 3 performs printing. In step S55, the control unit 301 sets the second flag to 1 and proceeds to the processing of step S49.

As in the above description, in the present embodiment, the fixing part 35 comes in contact with and heats the continuous print medium P, thereby fixing the image formed on the continuous print medium P. The fixing part 35 is capable of performing the temperature rise control of the fixing part 35 even in a state where the contact of the fixing part 35 with the continuous print medium P is released and the continuous print medium P is stopped. Specifically, unless the tension F is uniformly applied to the continuous print medium P, that is, when the tension F applied to the continuous print medium P is ununiform, the continuous print medium P might come in contact with the surface of the fixing belt 352c on the fixing surface side depending on the thermal deformation state of the continuous print medium P, even when the temperature rise control of the fixing part 35 is performed. The contact of a part of the continuous print medium P with the surface of the fixing belt 352c might lead to generation of a scratch on a surface of the fixing belt 352c. The scratch on the surface of the fixing belt 352c would cause image quality degradation. Therefore, in a case where the tension F is not uniformly applied to the continuous print medium P, the temperature rise control of the fixing part 35 would be prohibited. This can prevent a part of the continuous print medium P from coming in contact with the surface of the fixing belt 352c, making it possible to suppress an increase in printing cost and image quality degradation.

Furthermore, in the present embodiment, in a case where it is determined that the contact of the fixing part 35 with the continuous print medium P is released and the tension F is uniformly applied to the continuous print medium P, the temperature rise control is permitted. Releasing the contact of the fixing part 35 with the continuous print medium P would suppress direct heat transmission from the fixing nip N to the continuous print medium P. Still, there is a possibility that heat is transmitted through the air. In a case where the tension F is uniformly applied to the continuous print medium P in addition to the state where the contact of the fixing part 35 with the continuous print medium P is released, the tension F is uniformly applied to the continuous print medium P even when the continuous print medium P can be deformed by heat, and thus, it is possible to suppress deformation of the continuous print medium P. Accordingly, deformation of the continuous print medium P can be suppressed by the uniformly applied tension F even under a condition where heat is transmitted to the continuous print medium P via the air. This enables prevention of the contact of the part of the continuous print medium P with the surface of the fixing belt 352c, making it possible to suppress generation of a scratch on the surface of the fixing belt 352c. This leads to suppression of image quality degradation due to the scratch generated on the surface of the fixing belt 352c.

In a case where a conveyance distance of the continuous print medium P, that is, the distance by which the continuous print medium P is conveyed while being pinched by the fixing part 35 has reached a preset target distance in the present embodiment, it is determined that the tension F is uniformly applied to the continuous print medium P. It is known that, when the continuous print medium P is conveyed to a certain distance in the press contact state, the tension F is uniformly applied to the continuous print medium P. Therefore, when a conveyance distance of the continuous print medium P, that is, the distance by which the continuous print medium P is conveyed while being pinched by the fixing part 35, has reached a preset target distance, the tension F is uniformly applied to the continuous print medium P and thus, deformation of the continuous print medium P is suppressed. Therefore, it is possible to avoid a situation in which a part of the continuous print medium P comes in contact with the surface of the fixing belt 352c, making it possible to suppress generation of a scratch on the surface of the fixing belt 352c. This leads to suppression of image quality degradation due to the scratch generated on the surface of the fixing belt 352c.

Furthermore, in the present embodiment, in a case where a difference between the detection result of the first load detector 51_1 and the detection result of the second load detector 51_2 falls within a range of a preset load tolerance value, it is determined that the tension F is uniformly applied to the continuous print medium P. When the difference between the detection result of the first load detector 51_1 and the detection result of the second load detector 51_2 falls within the range of the preset load tolerance value, it is regarded as a state where the tension F applied to the continuous print medium P is uniform. Therefore, the assumption that the tension F is uniformly applied to the continuous print medium P would lead to no occurrence of floating of the continuous print medium P, suppressing the contact of a part of the continuous print medium P with the surface of the fixing belt 352c. This leads to suppression of image quality degradation because there is no scratch generated on the surface of the fixing belt 352c.

Furthermore, in the present embodiment, in a case where no slack has occurred on one end side or the other end side of the continuous print medium P on the basis of the detection results of the first slack detector 53_1 and the second slack detector 53_2, it is determined that the tension F is uniformly applied to the continuous print medium P. In a case where no slack has been found on one end side or the other end side of the continuous print medium P on the basis of the detection results of the first slack detector 53_1 and the second slack detector 53_2, it can be regarded that the tension F applied to the continuous print medium P is uniform. Therefore, when the state is equivalent to the state where the tension F is uniformly applied to the continuous print medium P, no floating of the continuous print medium P occurs. Accordingly, there would be no contact of the part of the continuous print medium P with the surface of the fixing belt 352c. This leads to suppression of image quality degradation because there is no scratch generated on the surface of the fixing belt 352c.

Furthermore, in the present embodiment, the continuous print medium P is wound around the second rotatable member 353 in a state where the tension F is uniformly applied. Therefore, since the continuous print medium P is pressed against the second rotatable member 353, the distance to the fixing belt 352c can be kept constant. The distance between the fixing belt 352c and the continuous print medium P being kept constant can avoid a situation where a part of the continuous print medium P comes in contact with the surface of the fixing belt 352c, leading to suppression of a scratch generated on the surface of the fixing belt 352c. This leads to suppression of image quality degradation due to the scratch generated on the surface of the fixing belt 352c. Furthermore, even in a case where the continuous print medium P is thermally deformed by the heat of the fixing belt 352c and causes deformation outside the surface of the continuous print medium P and deformation outside the surface of the continuous print medium P, the continuous print medium P would be wound around the second rotatable member 353 in a state where the tension F is applied, and pulled along the curvature surface of the second rotatable member 353. This result in producing a state where the extension of the continuous print medium P as the deformation of the continuous print medium P within the surface is absorbed while the deformation of the continuous print medium P outside the surface is suppressed. Therefore, even when thermal deformation occurs in the continuous print medium P, the contact with the fixing belt 352c would be avoided by maintaining the distance from the fixing belt 352c, making it possible to perform the temperature rise control in a state where the continuous print medium P is stopped without being conveyed. At this time, under the conditions including the type of continuous print medium P, the temperature of the first rotatable member 352, the temperature of the second rotatable member 353, the uniformity of the tension F, the operation history of the fixing part 35, which might cause contact between a part of the continuous print medium P and the surface of the fixing belt 352c, prohibiting the temperature rise control would ensure avoidance of the contact between a part of the continuous print medium P with the surface of the fixing belt 352c.

Furthermore, in the present embodiment, the maintenance control would be stopped in a case where the time for continuing the maintenance control of maintaining the temperature of the fixing part 35 at a target temperature of the temperature rise control has exceeded a threshold time. It would be possible to raise the temperature of the fixing part 35 to the target temperature of the temperature rise control and maintain the temperature of the fixing part 35 at the target temperature of the temperature rise control. However, maintaining the temperature of the fixing part 35 at the target temperature of the temperature rise control would waste energy. To avoid this, in consideration of the cost and influence of the load on the environment, and in order to maintain the temperature of the fixing part 35 at the target temperature of the temperature rise control at the time of alignment adjustment in a post process such as decoration or cutting, the temperature of the fixing part 35 is maintained at the target temperature of the temperature rise control until the threshold time elapsed. When the threshold time has elapsed, the maintenance control is stopped in consideration of the user convenience achieved by reduction of the warm-up time and cost and influence of load on environment achieved by avoidance of power saving.

Furthermore, in the present embodiment, the target temperature of the temperature rise control is changed in accordance with the type of continuous print medium P. The thermal deformation start temperature and the thermal deformation amount vary depending on the type of continuous print medium P. Specifically, when the continuous print medium P is of a type with a low thermal deformation start temperature, the thermal deformation amount would be increased by performing the temperature rise control of the fixing part 35. When the continuous print medium P is of a type having a large thermal deformation amount, the thermal deformation amount would be increased by performing the temperature rise control of the fixing part 35. Accordingly, there is a high possibility that a part of the continuous print medium P comes in contact with the surface of the fixing belt 352c. Therefore, in a case where the continuous print medium P is a type that can induce such situations, the target temperature of the temperature rise control can be lowered to prevent excessive thermal deformation of the continuous print medium P. As a result, it is possible to eliminate the possibility that a part of the continuous print medium P comes in contact with the surface of the fixing belt 352c.

Furthermore, in the present embodiment, the threshold time is changed in accordance with the thermal deformation amount of the continuous print medium P. The thermal deformation amount varies depending on the type of continuous print medium P. Specifically, when the continuous print medium P is of a type having a large thermal deformation amount, the thermal deformation amount would be increased by performing the temperature rise control of the fixing part 35. Accordingly, there is a high possibility that a part of the continuous print medium P comes in contact with the surface of the fixing belt 352c. Therefore, in a case where the continuous print medium P is a type that can induce such situations, the threshold time can be reduced to prevent excessive thermal deformation of the continuous print medium P. As a result, it is possible to eliminate the possibility that a part of the continuous print medium P comes in contact with the surface of the fixing belt 352c.

### Second Embodiment

In a second embodiment, descriptions of configurations and functions similar to those of the first embodiment will be omitted. In the second embodiment, the configurations of the sheet feeder 2, the image forming apparatus 3, and the winding apparatus 4 are similar to those of the first embodiment. The second embodiment is different from the first embodiment in permission determination processing of the temperature rise control, the temperature rise control, and the maintenance control of the image forming apparatus 3. That is, the second embodiment is different from the first embodiment in the various control functions such as the permission determination function of the temperature rise control, the temperature rise function, and the maintenance function, of the image forming apparatus 3.

Executing the temperature rise control with a present condition might not sufficiently suppress thermal deformation even after the tension F is uniformly applied to the continuous print medium P. In a case where such a state is expected, there is a need to change the present condition. Specifically, at least one of the thermal deformation start temperature and the thermal deformation amount differs for each of types of continuous print medium P. In a case where the thermal deformation start temperature of the continuous print medium P is low or the thermal deformation amount of the continuous print medium P is large, the control unit 301 decreases the target temperature of the temperature rise control or prohibits the temperature rise control. In a case where the temperature of the first rotatable member 352 out of the temperatures of the fixing part 35 is higher than the target temperature of the temperature rise control by the temperature rise by the heating source 352b, the control unit 301 prohibits temperature rise control until the temperature drops to a target temperature of cooling control of cooling the fixing part 35. The target temperature of the cooling control is set to a temperature lower than the target temperature of the temperature rise control. The cooling control drives the upper blower fan 356. In a case where the temperature of the second rotatable member 353 out of the temperatures of the fixing part 35 is higher than the target temperature of the temperature rise control, the control unit 301 prohibits temperature rise control until the temperature drops to a target temperature of cooling control. The cooling control drives the lower blower fan 357.

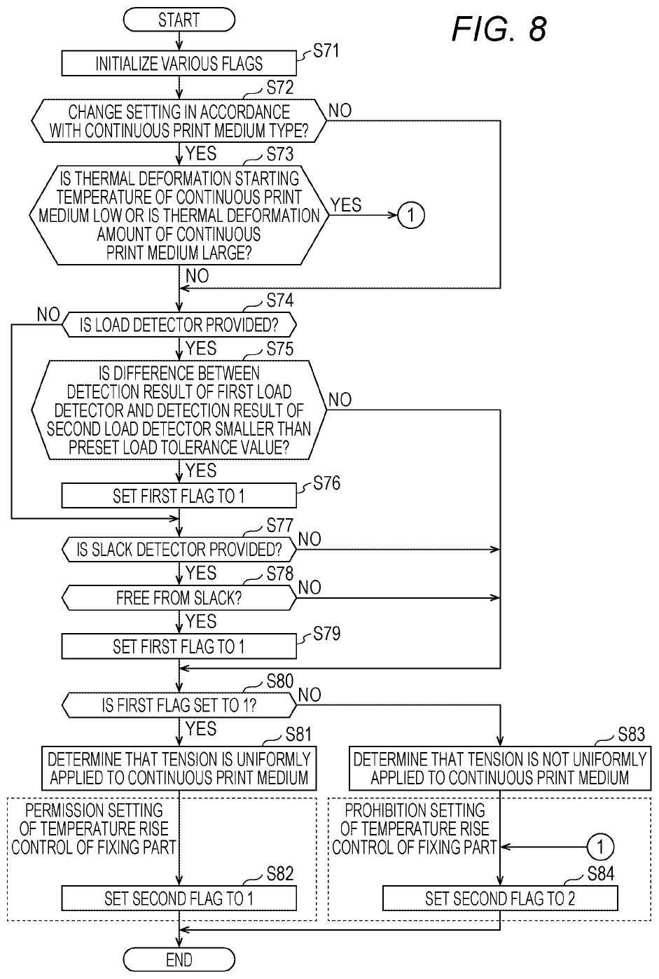

FIG. 8 is a flowchart illustrating an example of permission determination processing of temperature rise control of the image forming apparatus 3 according to the second embodiment of the present disclosure. Since the processing in step S71 and steps S74 to S84 is similar to the processing in steps S11 to S22 described above, description will be omitted. In step S72, the control unit 301 determines whether to change the setting in accordance with the type of the continuous print medium P. In the case the control unit 301 determines to change the setting in accordance with the type of the continuous print medium P (step S72; Y), processing proceeds to step S73. In the case the control unit 301 determines not to change the setting in accordance with the type of the continuous print medium P (step S72; N), processing proceeds to step S74. In step S73, in a case where the control unit 301 determines that the thermal deformation start temperature of the continuous print medium P is low or the thermal deformation amount of the continuous print medium P is large (step S73; Y), processing proceeds to step S84. In a case where the control unit 301 determines that the thermal deformation start temperature of the continuous print medium P is high or the thermal deformation amount of the continuous print medium P is small (step S73; N), processing proceeds to step S74.

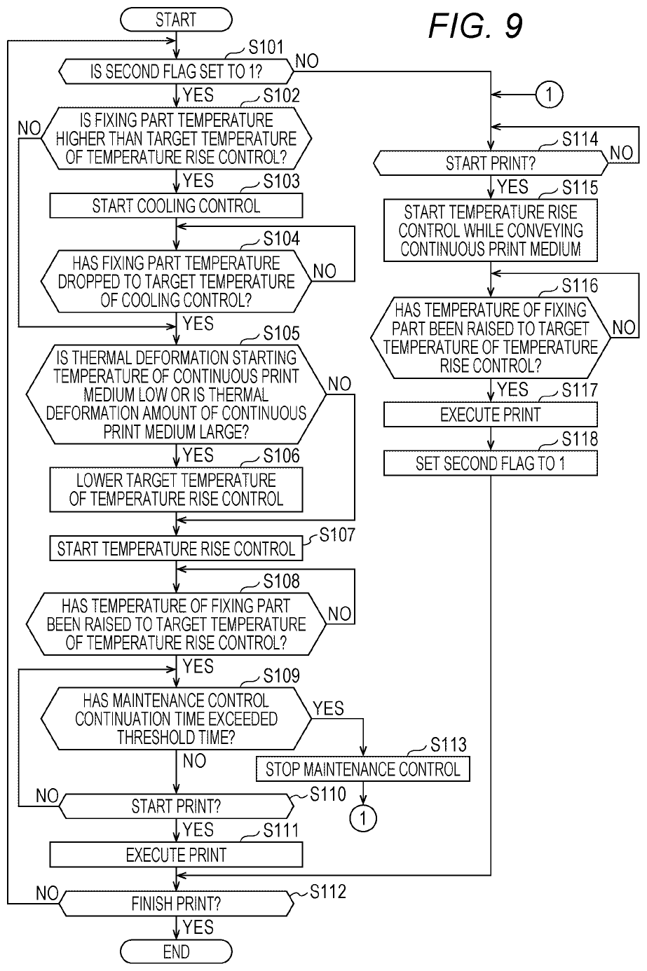

FIG. 9 is a flowchart illustrating an example of temperature rise control and maintenance control of the image forming apparatus 3 according to the second embodiment of the present disclosure. Since the processing of step S101 and steps S107 to S118 is similar to the processing of step S41 and steps S44 to S55 described above, description will be omitted. In step S102, the control unit 301 determines whether the temperature of the fixing part 35 is higher than the target temperature of the temperature rise control. In a case where the control unit 301 determines that the temperature of the fixing part 35 is higher than the target temperature of the temperature rise control (step S102; Y), processing proceeds to step S103. In a case where the control unit 301 determines that the temperature of the fixing part 35 is the target temperature of the temperature rise control or less (step S102; N), processing proceeds to step S105. In step S103, the control unit 301 starts cooling control. In step S104, the control unit 301 determines whether the temperature of the fixing part 35 has dropped to the target temperature of the cooling control. In a case where the control unit 301 determines that the temperature of the fixing part 35 has dropped to the target temperature of the cooling control (step S104; Y), processing proceeds to step S105. In a case where the control unit 301 determines that the temperature of the fixing part 35 has not dropped to the target temperature of the cooling control (step S104; N), the processing of step S104 is continued. In step S105, the control unit 301 determines whether the thermal deformation start temperature of the continuous print medium P is low or the thermal deformation amount of the continuous print medium P is large. In a case where the control unit 301 determines that the thermal deformation start temperature of the continuous print medium P is low or the thermal deformation amount of the continuous print medium P is large (step S105; Y), processing proceeds to step S106. In a case where the control unit 301 determines that the thermal deformation start temperature of the continuous print medium P is high or the thermal deformation amount of the continuous print medium P is small (step S105; N), processing proceeds to step S107. In step S106, the control unit 301 lowers the target temperature of the temperature rise control.

From the above description, in the present embodiment, the target temperature of the temperature rise control is lowered in a case where the thermal deformation start temperature of the continuous print medium P is low or the thermal deformation amount of the continuous print medium P is large. When the continuous print medium P is of a type with a low thermal deformation start temperature, the thermal deformation amount would be increased by performing the temperature rise control of the fixing part 35. When the continuous print medium P is of a type having a large thermal deformation amount, the thermal deformation amount would be increased by performing the temperature rise control of the fixing part 35. Accordingly, there is a high possibility that a part of the continuous print medium P comes in contact with the surface of the fixing belt 352c. Therefore, in a case where the continuous print medium P is a type that can induce such a situation, lowering the target temperature of the temperature rise control would enable elimination of the possibility that a part of the continuous print medium P and the surface of the fixing belt 352c comes in contact with each other.

Furthermore, in the present embodiment, in a case where the temperature of the first rotatable member 352 out of the temperatures of the fixing part 35 is higher than the target temperature of the temperature rise control by the temperature rise by the heating source 352b, the temperature rise control would be prohibited until the temperature drops to a target temperature of the cooling control of cooling the fixing part 35. When the temperature of the first rotatable member 352 out of the temperatures of the fixing part 35 becomes higher than the target temperature of the temperature rise control, the thermal deformation amount of the continuous print medium P exceeds the amount at the time of the target temperature of the temperature rise control. When the temperature rise control is started by stopping the conveyance of the continuous print medium P in a state where the temperature of the first rotatable member 352 out of the temperatures of the fixing part 35 is higher than the target temperature of the temperature rise control, a temperature difference between the continuous print medium P and the first rotatable member 352 would be increased, leading to a sudden occurrence of thermal deformation of the continuous print medium P. Therefore, even when the tension F is uniformly applied to the continuous print medium P, deformation of the continuous print medium P cannot be suppressed, and the deformed portion of the continuous print medium P and the surface of the fixing belt 352c come in contact with each other. Therefore, prohibiting the temperature rise control until the temperature of the first rotatable member 352 out of the temperatures of the fixing part 35 drops to the target temperature of the cooling control of cooling the fixing part 35 would make it possible to avoid an increase in the thermal deformation amount of the continuous print medium P.

Furthermore, in the present embodiment, in a case where the temperature of the second rotatable member 353 out of the temperatures of the fixing part 35 is higher than the target temperature of the temperature rise control, the temperature rise control would be prohibited until the temperature drops to the target temperature of the cooling control of cooling the fixing part 35. When the temperature of the second rotatable member 353 out of the temperatures of the fixing part 35 becomes higher than the target temperature of the temperature rise control, the thermal deformation amount of the continuous print medium P exceeds the thermal deformation amount at the time of the target temperature of the temperature rise control. When the temperature rise control is started by stopping the conveyance of the continuous print medium P in a state where the temperature of the second rotatable member 353 out of the temperatures of the fixing part 35 is higher than the target temperature of the temperature rise control, a temperature difference between the continuous print medium P and the second rotatable member 353 would be increased, leading to a sudden occurrence of thermal deformation of the continuous print medium P. Therefore, even when the tension F is uniformly applied to the continuous print medium P, deformation of the continuous print medium P cannot be suppressed, and the deformed portion of the continuous print medium P and the surface of the fixing belt 352c come in contact with each other. Therefore, prohibiting the temperature rise control until the temperature of the second rotatable member 353 out of the temperatures of the fixing part 35 drops to the target temperature of the cooling control of cooling the fixing part 35 would make it possible to avoid an increase in the thermal deformation amount of the continuous print medium P.

### Third Embodiment

In a third embodiment, descriptions of configurations and functions similar to those of the first and second embodiments will be omitted. In the third embodiment, the configurations of the sheet feeder 2, the image forming apparatus 3, and the winding apparatus 4, together with the temperature rise control and maintenance control, are similar to those of the first and second embodiments. The third embodiment is different from the first and second embodiments in permission determination processing of the temperature rise control of the image forming apparatus 3. That is, the third embodiment is different from the first and second embodiments in permission determination function of the temperature rise control of the image forming apparatus 3.

It is expected that, in a case immediately after turning on the power supply to the image forming apparatus 3, in a case where the continuous print medium P has been replaced, or in a case where jam processing has been performed in the image forming apparatus 3, executing the temperature rise control with no consideration would lead to a state where the tension F is not uniformly applied to the continuous print medium P. Therefore, when an occurrence of such a state is expected, it is necessary to determine this possibility and necessary to prohibit the temperature rise control temporarily and perform remedial processing. Specifically, when the image forming apparatus 3 is in the state immediately after the power supply is turned on, the control unit 301 determines that the tension F is not uniformly applied to the continuous print medium P. The control unit 301 determines that the tension F is not uniformly applied to the continuous print medium P in a case where replacement of the continuous print medium P has been performed. The control unit 301 determines that the tension F is not uniformly applied to the continuous print medium P in a case where jammed processing of the continuous print medium P has been performed. As described above, in a case where the control unit 301 determines that the tension F is not uniformly applied to the continuous print medium P, the control unit 301 prohibits the temperature rise control. Note that, as described with reference to FIG. 7, the remedial processing may preferably be performed as processing up to step S53, that is, conveyance is preferably performed until the conveyance distance of the continuous print medium P reaches the target distance.

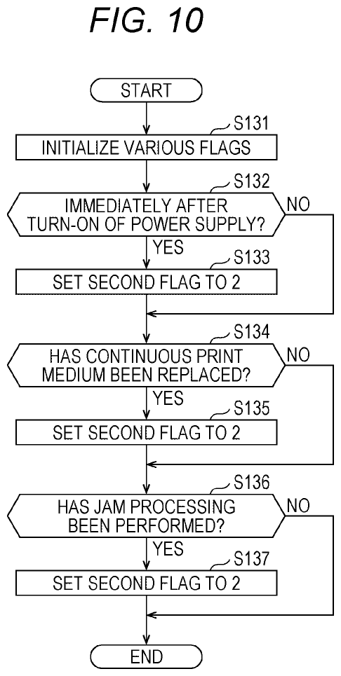

FIG. 10 is a flowchart illustrating an example of permission determination processing of temperature rise control of the image forming apparatus 3 according to the third embodiment of the present disclosure. In step S131, the control unit 301 initializes various flags. In step S132, the control unit 301 determines whether the timing is immediately after power supply is turned on. In a case where the control unit 301 determines that the timing is immediately after power supply is turned on (step S132; Y), processing proceeds to step S133. In a case where the control unit 301 determines that the timing is not immediately after power supply is turned on (step S132; N), the processing proceeds to step S134. In step S133, the control unit 301 sets the second flag to 2. In step S134, the control unit 301 determines whether replacement of the continuous print medium P has been performed. In a case where the control unit 301 determines that the continuous print medium P has been replaced (step S134; Y), processing proceeds to step S135. In a case where the control unit 301 determines that replacement of the continuous print medium P has not been performed (step S134; N), the processing proceeds to step S136. In step S135, the control unit 301 sets the second flag to 2. In step S136, the control unit 301 determines whether jam processing has been performed on the continuous print medium P. In a case where the control unit 301 determines that jam processing has been performed on the continuous print medium P (step S136; Y), processing proceeds to step S137. In a case where the control unit 301 determines that jam processing has not been performed on the continuous print medium P (step S136; N), processing of steps S131 to S137 is finished. In step S137, the control unit 301 sets the second flag to 2, and finishes the processing of steps S131 to S137.

From the above, in the present embodiment, in a case where the image forming apparatus 3 is in a state where the power supply is immediately after turned on, it is determined that the tension F is not uniformly applied to the continuous print medium P. The tension F is applied to the continuous print medium P by the tension application mechanism 61. The tension application mechanism 61 operates on the power supplied. Accordingly, since the tension application mechanism 61 would not operate unless power is supplied, the continuous print medium P would be in a slack state during a period after power supply is interrupted and before the power supply is turned on. This would result in a state where the continuous print medium P is loosely wound around the second rotatable member 353. This might produce an unstable positional relationship relative to the fixing part 35, leading to skewed winding. In such a case, even when power supply for the image forming apparatus 3 is turned on and the tension application mechanism 61 is operated to apply the tension F to the continuous print medium P, it is difficult to uniformly press the continuous print medium P against the second rotatable member 353. Accordingly, a slack might occur in the portion of the continuous print medium P that is wound around the second rotatable member 353. The tension F would not be applied to such a slack portion. Therefore, performing warming-up by the temperature rise control in this state would bring the slack portion into contact with the fixing belt 352c. This results in generation of a scratch on the surface of the fixing belt 352c, leading to image quality degradation. In order to avoid such a situation, when the timing is immediately after turning on the power supply of the image forming apparatus 3, it is determined that the tension F is not uniformly applied to the continuous print medium P, thereby prohibiting the temperature rise control and suppressing the warm-up operation.

Furthermore, in the present embodiment, it is determined that the tension F is not uniformly applied to the continuous print medium P when the continuous print medium P has been replaced. In general, the continuous print medium P is replaced by a procedure including: cutting a portion of the continuous print medium P1 in the sheet feeder 2; loading a new roll type continuous print medium P1 into the sheet feeder 2; and then connecting the cut portion and the new roll type continuous print medium P1 using a tape or the like. Therefore, the portion connected with the continuous print medium P1 might be skewed or deflected in some cases. After connecting the continuous print medium P1, it is common to convey the continuous print medium P1 up to the winding apparatus 4. However, some users might not convey the medium to the winding apparatus 4 in order to reduce sheet spoilage. In a case where the temperature rise control is started without conveyance of the medium to the winding apparatus 4, a joint portion of the continuous print medium P1 might come to the second rotatable member 353 in some cases. Such a case would make it difficult to pull and wind the continuous print medium P1 along the curvature surface of the second rotatable member 353 due to skew or deflection of the continuous print medium P1, and this might bring a part of the continuous print medium P1 and the surface of the fixing belt 352c into contact with each other. To avoid this, after replacement of the continuous print medium P1, it is determined that the tension F is not uniformly applied to the continuous print medium P1, thereby prohibiting the temperature rise control and suppressing the warm-up operation.

Furthermore, in the present embodiment, it is determined that the tension F is not uniformly applied to the continuous print medium P when the jam processing of the continuous print medium P has been performed. When a sheet jam or other jam occurs, the tension F applied to the continuous print medium P is released and then, jam processing is performed. Therefore, there is a possibility that the positional relationship between the continuous print medium P and the second rotatable member 353 is changed. That is, even with the tension F applied again, it is now difficult to pull and wind the continuous print medium P around the curvature surface of the second rotatable member 353, causing a part of the continuous print medium P to come in contact with the surface of the fixing belt 352c. Therefore, after the jam processing of the continuous print medium P has been performed, it is determined that the tension F is not uniformly applied to the continuous print medium P, thereby prohibiting the temperature rise control and suppressing the warm-up operation.

### Fourth Embodiment

In a fourth embodiment, descriptions of configurations and functions similar to those of the first to third embodiments will be omitted. In the fourth embodiment, the configurations of the sheet feeder 2, the image forming apparatus 3, and the winding apparatus 4 and the permission determination function of the image forming apparatus 3 are similar to those of the first to third embodiments. The fourth embodiment is different in various control functions such as the temperature rise function and the maintenance function of the image forming apparatus 3.

In order to enable the warm-up in a state where conveyance of the continuous print medium P is stopped, it is required, as described above, that the tension F is uniformly applied to the continuous print medium P in a state where the first rotatable member 352 and the second rotatable member 353 are separated from each other. Accordingly, it is necessary to uniformly apply the tension F to the continuous print medium P. However, when the tension F applied to the continuous print medium P is released, or replacement of the continuous print medium P or jam processing has been performed, it would be difficult to apply the tension F uniformly to the continuous print medium P. To avoid this, when such a state is expected, the maintenance control is to be temporarily stopped. Specifically, the control unit 301 stops the maintenance control in a case where the tension F applied to the continuous print medium P is released. The control unit 301 stops the maintenance control when the continuous print medium P has been replaced. The control unit 301 stops the maintenance control when jam processing of the continuous print medium P has been performed.

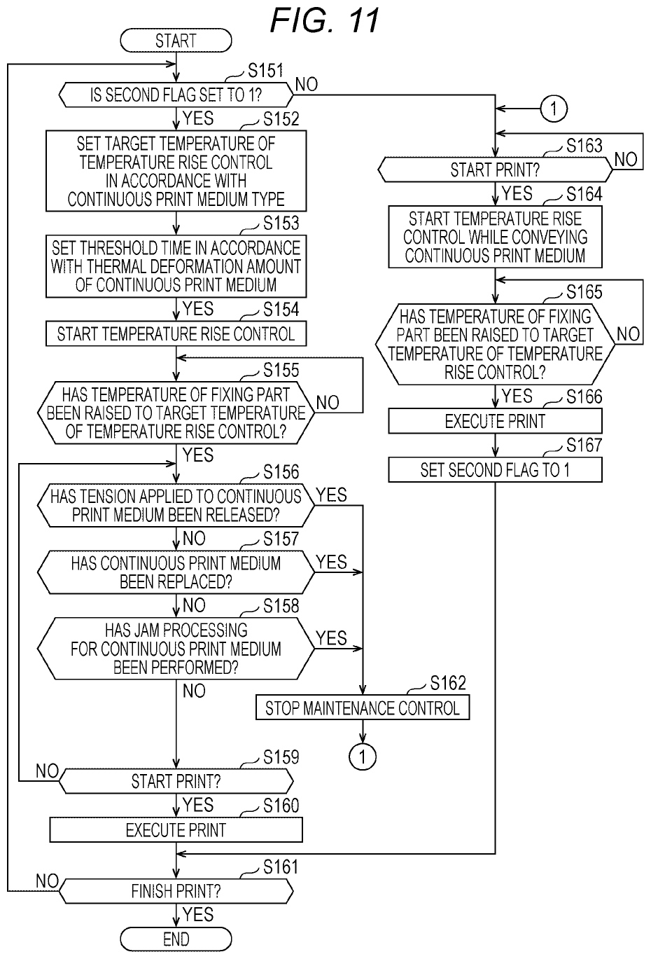

FIG. 11 is a flowchart illustrating an example of temperature rise control and maintenance control of the image forming apparatus 3 according to the fourth embodiment of the present disclosure. Since the processing of steps S151 to S155 and steps S159 to S167 are similar to the above-described steps S41 to S45 and steps S47 to S55, description will be omitted. In step S156, the control unit 301 determines whether the tension F applied to the continuous print medium P has been released. In a case where the control unit 301 determines that the tension F applied to the continuous print medium P has been released (step S156; Y), processing proceeds to step S162. In a case where the control unit 301 determines that the tension F applied to the continuous print medium P has not been released (step S156; N), processing proceeds to step S157. In step S157, the control unit 301 determines whether replacement of the continuous print medium P has been performed. In a case where the control unit 301 determines that the replacement of the continuous print medium P has been performed (step S157; Y), processing proceeds to step S162. In a case where the control unit 301 determines that replacement of the continuous print medium P has not been performed (step S157; N), the processing proceeds to step S158. In step S158, the control unit 301 determines whether jam processing has been performed on the continuous print medium P. In a case where the control unit 301 determines that jam processing has been performed on the continuous print medium P (step S158; Y), processing proceeds to step S162. In a case where the control unit 301 determines that jam processing has not been performed on the continuous print medium P (step S158; N), processing proceeds to step S159.

From the above, in the present embodiment, when the tension F applied to the continuous print medium P has been released, the maintenance control is stopped. When the tension F applied to the continuous print medium P is released, it is difficult to uniformly apply the tension F to the continuous print medium P. Therefore, when the tension F applied to the continuous print medium P is released, it is difficult to maintain the distance between the continuous print medium P and the fixing belt 352c in a case where thermal deformation occurs, and this would not avoid the contact with the surface of the fixing belt 352c. Therefore, this is under a situation where the temperature rise control cannot be performed in a state where the continuous print medium P is stopped, that is, not being conveyed. Accordingly, the maintenance control is stopped so as to avoid generation of a scratch on the surface of the fixing belt 352c.

Furthermore, in the present embodiment, the maintenance control is stopped in a case where replacement of the continuous print medium P has been performed. When replacement of the continuous print medium P has been performed, it is difficult to pull and wind the continuous print medium P along the curvature surface of the second rotatable member 353 due to skew or deflection of the continuous print medium P, and this might bring a part of the continuous print medium P and the surface of the fixing belt 352c into contact with each other. Therefore, after the replacement of the continuous print medium P, the maintenance control is stopped so as to avoid generation of a scratch on the surface of the fixing belt 352c.

Furthermore, in the present embodiment, the maintenance control is stopped in a case where jam processing has been performed on the continuous print medium P. When jam processing of the continuous print medium P is performed, there is a possibility that the relative positional relationship between the continuous print medium P and the second rotatable member 353 is changed. That is, even with the tension F applied again after jam processing of the continuous print medium P, it is now difficult to pull and wind the continuous print medium P around the curvature surface of the second rotatable member 353, causing a part of the continuous print medium P to come in contact with the surface of the fixing belt 352c. Accordingly, stopping the maintenance control after the jam processing has been performed on the continuous print medium P would avoid the generation of a scratch on the surface of the fixing belt 352c.

While the image forming apparatus 3 according to embodiments of the present disclosure has been described as above, the present disclosure is not limited thereto, and may be modified without departing from the scope and spirit of the present disclosure.

For example, the present embodiment has described an example of a configuration in which the first rotatable member 352 includes the fixing belt 352c as the belt heating system. However, the present disclosure is not particularly limited this this example. For example, the first rotatable member 352 may be configured as a roller heating system. Moreover, while the above includes an example in which the second rotatable member 353 functions as a lower pressure roller as a roller pressure method, the present disclosure is not particularly limited to this example. For example, the second rotatable member 353 may include a pressure belt as a belt pressure method.

In addition, while the above includes an example in which the tension application mechanism 61 is provided in each of the sheet feeder 2 and the winding apparatus 4, the present disclosure is not particularly limited to this example. For example, the tension application mechanism 61 may be provided in the image forming apparatus 3. Further, the above includes an example in which the tension application mechanism 61 applies tension F to the continuous print medium P by using the weight 613, the present disclosure is not particularly limited to this example. For example, a load may be applied to the dancer roller 612 by using an air cylinder or a spring to apply pressure to the dancer roller 612, thereby applying the tension F to the continuous print medium P. Note that in the case of air cylinder, the pressure fluctuation of the air leads to the fluctuation of the tension F in pressurization of air cylinder. In the case of a spring, a damper for stabilizing the spring is provided.

While the above includes an example in which the slack detector 53 uses a non-contact type detector, the present disclosure is not limited to this example. For example, the slack detector 53 may use a contact type detector.

While the above includes an example using various flags for each of the above processes, the present disclosure is not particularly limited to this example.

Moreover, while the above includes an example of using the electrophotographic image forming apparatus 3, the present disclosure is not particularly limited to this example. For example, an inkjet type apparatus may be used. In a case where the image forming apparatus 3 according to the present disclosure is applied to an inkjet type apparatus, it is possible to suppress an increase in printing cost and image quality degradation even when heat is applied to quickly fix the ink.

Although embodiments of the present disclosure have been described and illustrated in detail, the disclosed embodiments are made for purposes of illustration and example only and not limitation. The scope of the present disclosure should be interpreted by terms of the appended claims.

As used throughout this application, the words “can” and “may” are used in a permissive sense (i.e., meaning having the potential to), rather than the mandatory sense (i.e., meaning must). The words “include”, “including”, and “includes” and the like mean including, but not limited to. As used herein, the singular form of “a”, “an”, and “the” include plural references unless the context clearly dictates otherwise. As employed herein, the term “number” shall mean one or an integer greater than one (i.e., a plurality).

Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. An image forming apparatus capable of forming an image on a continuous print medium, the image forming apparatus comprising:
a fixing part that contacts and heats a continuous print medium so as to fix an image formed on the continuous print medium; and
a hardware processor that performs temperature rise control of the fixing part,
wherein the fixing part is capable of performing temperature rise control of the fixing part in a state where the contact of the fixing part with respect to the continuous print medium is released and the continuous print medium is stopped, and
wherein the hardware processor prohibits the temperature rise control of the fixing part in a case where the hardware processor determines that a tension is not uniformly applied to the continuous print medium.

2. The image forming apparatus according to claim 1, wherein, in a case where the hardware processor determines that the contact of the fixing part with respect to the continuous print medium is released and a tension is uniformly applied to the continuous print medium, the hardware processor permits the temperature rise control.

3. The image forming apparatus according to claim 1, wherein, in a case where a conveyance distance of the continuous print medium, which is a distance by which the continuous print medium is conveyed while being pinched by the fixing part, has reached a preset target distance, the hardware processor determines that a tension is uniformly applied to the continuous print medium.

4. The image forming apparatus according to claim 1, further comprising:
a first load detector that is provided at one end side of both ends on a short side of the continuous print medium and that detects a load on one end side of the continuous print medium; and
a second load detector that is provided at the other end side of both ends on the short side of the continuous print medium and that detects a load on the other end side of the continuous print medium,
wherein, in a case where a difference between a detection result of the first load detector and a detection result of the second load detector falls within a range of a preset load tolerance value, the hardware processor determines that a tension is uniformly applied to the continuous print medium.

5. The image forming apparatus according to claim 1, further comprising:
a first slack detector that is provided at one end side of both ends on a short side of the continuous print medium and that detects a slack at one end side of the continuous print medium; and
a second slack detector that is provided on the other end side of both ends on the short side of the continuous print medium and that detects a slack at the other end side of the continuous print medium,
wherein, in a case where a slack is not found on the one end side and the other end side of the continuous print medium on the basis of detection results of the first slack detector and the second slack detector, the hardware processor determines that a tension is uniformly applied to the continuous print medium.

6. The image forming apparatus according to claim 1, wherein the hardware processor lowers a target temperature of the temperature rise control or prohibits the temperature rise control on the basis of a thermal deformation start temperature or a thermal deformation amount corresponding to a type of the continuous print medium.

7. The image forming apparatus according to claim 1, wherein the fixing part includes:
a first rotatable member having a heating source; and
a second rotatable member that is in press contact with the first rotatable member and forms a fixing nip and that conveys the continuous print medium while pinching the continuous print medium at the fixing nip, and
wherein, in a case where temperature of the first rotatable member out of temperatures of the fixing part is higher than a target temperature of the temperature rise control due to a temperature rise by the heating source, the hardware processor prohibits the temperature rise control until the temperature of the first rotatable member drops to a target temperature of cooling control of cooling the fixing part.

8. The image forming apparatus according to claim 7, wherein, in a case where temperature of the second rotatable member out of the temperatures of the fixing part is higher than the target temperature of the temperature rise control, the hardware processor prohibits the temperature rise control until the temperature drops to the target temperature of the cooling control.

9. The image forming apparatus according to claim 7, wherein the continuous print medium is wound around the second rotatable member in a state where a tension is uniformly applied to the continuous print medium.

10. The image forming apparatus according to claim 1, wherein, in a case where the image forming apparatus is in a state immediately after power supply is turned on, the hardware processor determines that a tension is not uniformly applied to the continuous print medium.

11. The image forming apparatus according to claim 1, wherein, in a case where replacement of the continuous print medium has been performed, the hardware processor determines that a tension is not uniformly applied to the continuous print medium.

12. The image forming apparatus according to claim 1, wherein, in a case where jam processing of the continuous print medium has been performed, the hardware processor determines that a tension is not uniformly applied to the continuous print medium.

13. The image forming apparatus according to claim 1, wherein, in a case where a time for continuing maintenance control of maintaining a temperature of the fixing part at a target temperature of the temperature rise control has exceeded a threshold time, the hardware processor stops the maintenance control.

14. The image forming apparatus according to claim 13, wherein the hardware processor sets the target temperature of the temperature rise control in accordance with a type of the continuous print medium.

15. The image forming apparatus according to claim 13, wherein the hardware processor sets the threshold time in accordance with a thermal deformation amount of the continuous print medium.

16. The image forming apparatus according to claim 13, wherein the hardware processor stops the maintenance control in a case where a tension applied to the continuous print medium has been released.

17. The image forming apparatus according to claim 13, wherein the hardware processor stops the maintenance control in a case where replacement of the continuous print medium has been performed.

18. The image forming apparatus according to claim 13, wherein the hardware processor stops the maintenance control in a case where jam processing of the continuous print medium has been performed.

19. A non-transitory recording medium storing a computer readable program that causes a computer, which controls an image forming apparatus, including a fixing part that comes in contact with and heats a continuous print medium so as to fix an image formed on a continuous print medium and capable of forming an image on the continuous print medium, to implement:
executing a control function of performing temperature rise control of the fixing part,
wherein the temperature rise control of the fixing part is enabled in a state where the contact of the fixing part with respect to the continuous print medium is released and the continuous print medium is stopped, and
wherein the control function prohibits the temperature rise control of the fixing part in a case where the control function determines that a tension is not uniformly applied to the continuous print medium.
